(19) United States
(12) Patent Application Publication
(10) Pub. No.: US 2002/0126587 A1
(43) Pub. Date: Sep. 12, 2002

(54) Apparatus for recording and playing back information

(75) Inventors: Tsutomu Ohtani, Yamanashi (JP); Masayoshi Murayama, Yamanashi (JP); Hiroshi Kida, Yamanashi (JP); Masaaki Saito, Yamanashi (JP); Ichiro Miyake, Tokorozawa-City (JP); Tsutomu Takahashi, Tokorozawa-City (JP); Kenichiro Tada, Tokorozawa-City (JP); Yasuyuki Noda, Tokorozawa-City (JP); Gaku Yamamura, Tokorozawa-City (JP); Kazutomo Watanabe, Tokorozawa-City (JP)

Correspondence Address: SUGHRUE MION, PLLC, 2100 Pennsylvania Avenue, NW, Washington, DC, 20037-3213, US

(73) Assignee: PIONEER CORPORATION, SHIZUOKA PIONEER CORPORATION

(21) Appl. No.: 10/058,222

(22) Filed: Jan. 29, 2002

(30) Foreign Application Priority Data
Jan. 29, 2001 (JP) 2001-19824

(51) Int. Cl. G11B 7/085

(52) U.S. Cl. 369/30.05

(57) ABSTRACT

An information record/playback machine includes a playback unit for reading a selected piece of information from a plurality of pieces of information recorded on a recording medium to play back the selected piece of information. The machine also includes a flag setting unit for preparing a flag indicating that the selected piece of information currently played should be deleted, in response to a command issued while the playback unit is playing the selected piece of information. The flag is attached to the selected piece of information. The machine further includes a display unit for displaying a list of all the pieces of information recorded on the recording medium except for the selected piece of information to which the flag is attached.

### BACKGROUND OF THE INVENTION

1. Field of the Invention

The present invention relates to an apparatus for recording a plurality of pieces of information on a recording medium and reproducing information recorded thereon.

2. Description of the Related Art

In recent times, a hard disc recorder and a hard disc are sometimes utilized, instead of a video tape recorder and a video tape, to record a broadcast program such as a TV program. The hard disc is fixedly provided, as a recording medium, in the hard disc recorder. Received programs are successively recorded on the hard disc. When playing back (or reproducing) a desired program from the hard disc, a user operates the hard disc recorder to have a list of all the recorded programs in a display screen of the hard disc recorder. The user then selects a desired program from the list to reproduce the desired program. If too many programs are included in the list, it is troublesome for the user to select a desired program. In general, therefore, the user deletes programs which are believed to be no longer necessary.

In order to delete a certain program from the hard disc, the user causes the hard disc recorder to show the list of the recorded programs, and finds out a target program. The user then selects the target program such that the hard disc recorder plays back the target program. The user watches the reproduced program for a while to confirm if this program is really unnecessary. When no necessity is confirmed, the user operates the hard disc recorder again to have the list of the recorded programs and searches for the target program. The user then specifies the target program and presses a deletion switch.

As described above, the user of the hard disc recorder must perform various bothersome operations to delete a desired one of the programs recorded on the hard disc.

### SUMMARY OF THE INVENTION

An object of the present invention is to provide an information record/playback apparatus that allows a user to delete a desired information data from a recording medium with an easy operation.

According to one aspect of the present invention, there is provided an information record/playback apparatus for recording a plurality of pieces of information on a recording medium and reproducing information recorded thereon comprising: a playback unit for reading a selected piece of information from a plurality of pieces of information recorded on the recording medium to play back the selected piece of information; a flag setting unit for preparing a deletion flag indicating that the selected piece of information currently played should be deleted, in response to a deletion command issued while the playback unit is reading or playing the selected piece of information, and for attaching the deletion flag to the selected piece of information; and a generating unit for generating a list of all the pieces of information recorded on the recording medium except for the selected piece of information to which the deletion flag is attached. Since the name of the played back piece of information is deleted from the recordation list in response to the deletion command made during the playing back, a user of the record/playback apparatus can easily delete desired information or data.

The information record/playback apparatus may further include a control unit for rendering a recording area of the selected piece of information to which the deletion flag is attached overwritable when a remaining recording capacity of the recording medium is less than a predetermined capacity. The information record/playback apparatus may further include an operation unit having a deletion button for issuing the deletion command. The generating unit may generate a confirmation message to the user before the deletion command is issued. The recording medium may be a hard disc, a video tape, an optical disc or a semiconductor.

### BRIEF DESCRIPTION OF THE DRAWINGS

FIG. 1 illustrates an inside structure of a hard disc recorder, which is an example of an information record/playback apparatus according to the present invention;

FIG. 2 illustrates storage regions on a hard disc shown in FIG. 1;

FIG. 3 illustrates a control panel of an operation unit shown in FIG. 1;

FIG. 4 illustrates a recorded program list stored in a memory shown in FIG. 1;

FIG. 5 illustrates a display screen to show the recorded program list;

FIG. 6 illustrates a program deletion subroutine executed upon clicking a program deletion button;

FIG. 7 illustrates a display screen to confirm program deletion;

FIG. 8 illustrates another program deletion subroutine executed upon pressing another program deletion button;

FIG. 9 illustrates a subroutine for recovering a deleted program; and

FIG. 10 illustrates a display screen to show a deleted program list.

### DETAILED DESCRIPTION OF THE INVENTION

Embodiments of the present invention will be described in reference to the accompanying drawings.

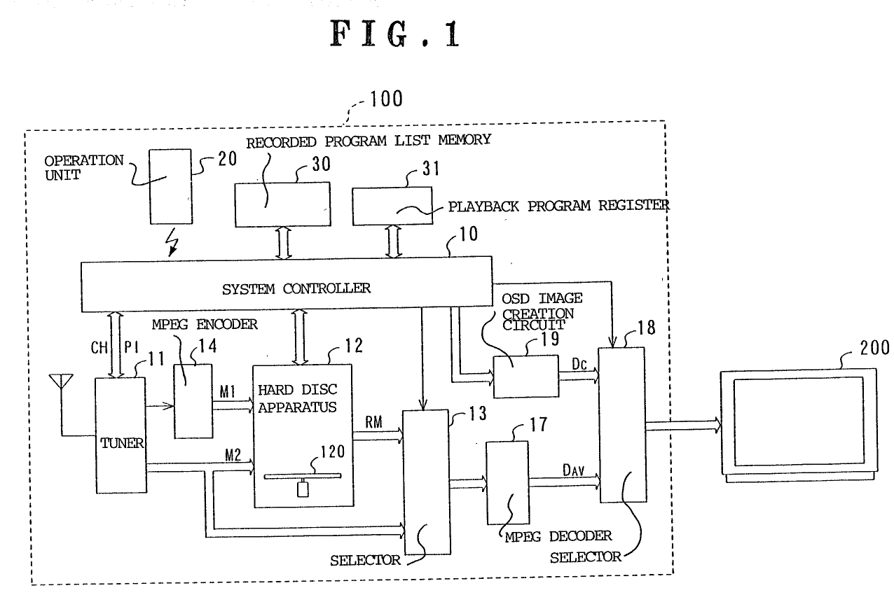

Referring to FIG. 1, illustrated is a schematic block diagram of a hard disc recorder 100, which is an example of an information record/playback apparatus according to the present invention.

A tuner 11 receives an airwave (channel) designation signal CH from a system control circuit 10. The airwave designation signal CH is used to designate a certain airwave in a plurality of analog television airwaves (NTSC, PAL or SECAM). The tuner 11 then accepts the designated analog television airwave, and demodulates the analog television airwave signal to a television signal. The television signal is supplied to an MPEG encoder 14 from the tuner 11. The MPEG encoder 14 applies an MPEG (Moving Picture Experts Group) coding process to the television signal to obtain an MPEG signal M1. The MPEG encoder 14 then feeds the MPEG signal M1 to a hard disc apparatus 12. When the tuner 11 receives another airwave designation signal CH, which designates a certain digital airwave, from the system control circuit 10, the tuner 11 accepts a designated digital airwave. The tuner 11 demodulates the digital airwave signal to obtain another MPEG signal M2, and supplies the MPEG signal M2 to the hard disc apparatus 12 and a selector 13 respectively.

The tuner 11 also extracts electronic program guidance information from the received airwave. With this guidance information, the tuner 11 creates program information PI representing a name of the broadcast program just received, a date of broadcasting, a channel number, etc. The tuner 11 then feeds the program information PI to the system control circuit 10.

The hard disc apparatus 12 records a series of MPEG signals M1 or M2, which carry the received broadcast program, on a hard disc 120 in response to a recordation command supplied from the system control circuit 10. The hard disc apparatus 12 retrieves the MPEG signals recorded on the hard disc 120 in accordance with a playback command supplied from the system control circuit 10, and supplies the retrieved MPEG signals RM to the selector 13. These MPEG signals are referred to as playback MPEG signals.

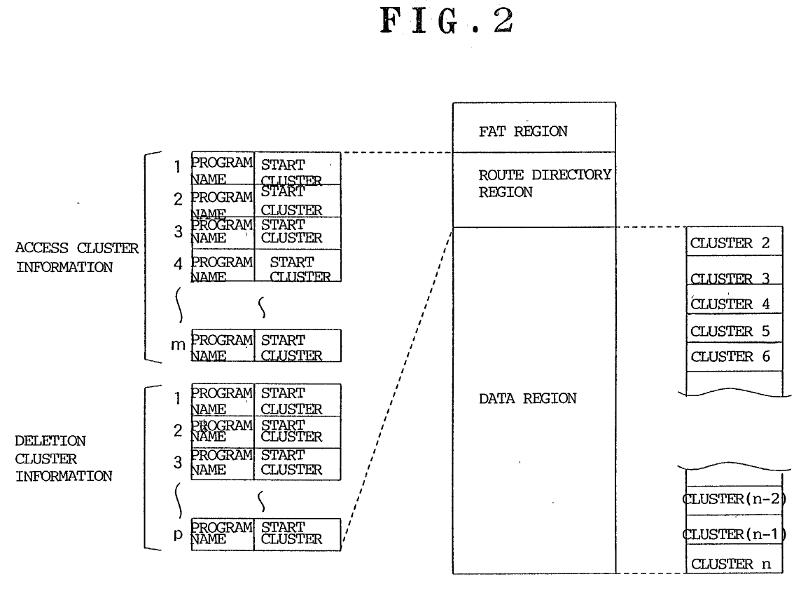

Referring to FIG. 2, illustrated is a schematic structure of a recording area on the hard disc 120.

A data region of the recording area is divided by a plurality of clusters. A FAT region includes information of next cluster (i.e., which cluster should be accessed next) for each of the clusters. The next cluster is specified by an appended number. The access is recordation or playback. A series of MPEG signals that carry one broadcast program are recorded over a plurality of clusters in accordance with the order determined by the information recorded in the FAT region. A route directory region includes access cluster information representing relationship between names of programs recorded in the data region and record initiation clusters of the recorded programs. The route directory region also includes deleted cluster information representing relationship between names of the deleted programs and record initiation clusters of the deleted programs.

The selector 13 selects one of the two MPEG signals, either the playback MPEG signal RM supplied from the hard disc apparatus 12, or the MPEG signal M2 supplied from the tuner 11, in accordance with a selection signal issued from the system control circuit 10. The selector 13 supplies the selected MPEG signal to an MPEG decoder 17. The MPEG decoder 17 applies an MPEG decoding process to the MPEG signal to obtain an audio/ video signal D_{AV}. The audio/video signal D_{AV} is introduced to a second selector 18. An OSD (On Screen Display) image creation circuit 19 creates an image signal D_{C} , which is used to display various messages and/or images fed from the system control circuit 10. The image signal D_{C} is introduced to the second selector 18. The second selector 18 selects one of the audio/video signal D_{AV} and the image signal D_{C} in accordance with a selection signal fed from the system control circuit 10. The selected signal is transferred to a display device 200. The display device 200 displays an image on the basis of the audio/video signal D_{AV} or the image signal D_{C} supplied from the hard disc recorder 100.

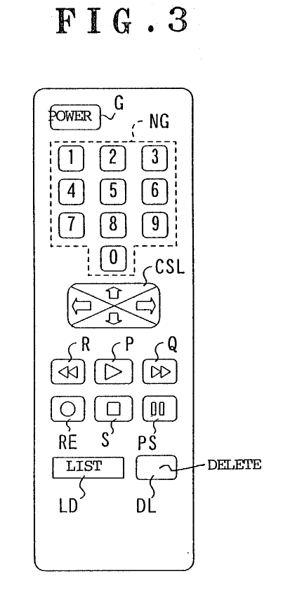

An operation unit 20 is, for example, a remote controller having a control panel as shown in FIG. 3. The control panel includes a power switch G for turning on and off the hard disc recorder 100, a group of numeric buttons NG for specifying a channel and/or entering numbers, and a cursor button CSL for moving a selection box or frame (will be described) within a display screen of the display device 200. The control panel also includes a playback button P for causing the hard disc recorder 100 to play back a recorded image, a quick-forward button Q, a rewind button R, a pause button PS, a stop button S and a recordation button RE. The control panel also includes a list display button LD for displaying a list of all the programs recorded on the hard disc 120, and a delete button DL for deleting a program.

The operation unit 20 is operated by a user and generates an operation signal corresponding to the pressed button. The operation unit 20 transmits the operation signal to the system control circuit 10 by means of a short-distance radio interface such as infrared radiation or Bluetooth.

The system control circuit 10 receives the operation signal from the operation unit 20 and controls the hard disc recorder 100 in accordance with the operation signal.

Operations of the hard disc recorder 100 under the control of the system control circuit 10 will be described in detail. The operations include use of the display device 200 as a television monitor, recordation of a television program, playback of the same, program deletion and deleted program recovery.

(1) TV Monitor

When a user wants to watch a TV show in realtime, the user first presses a certain button in the numeric button group NG on the remote controller 20 to specify a desired channel. The remote controller 20 supplies a television monitor command to the system control circuit 10. Upon receiving the television monitor command signal, the system control circuit 10 feeds a channel designation signal CH, which represents the desired channel, to the tuner 11. At the same time, the system control circuit 10 supplies a selection signal to the first selector 13 such that the MPEG signal M2, which is supplied from the turner 11, will be transferred to the MPEG decoder 17. In addition, the system control circuit 10 feeds a selection signal to the second selector 18 such that the audio/video signal D_{AV} derived from the MPEG decoder 17 will be transferred to the display device 200. As a result, the MPEG signal M2, which is received and demodulated by the tuner 11, is decoded to the audio/video signal D_{AV} by the PMEG decoder 17 and introduced to the display device 200. Accordingly, the display device 200 displays a digital television show of the desired channel, which is received at the tuner 11, in realtime.

(2) Recordation

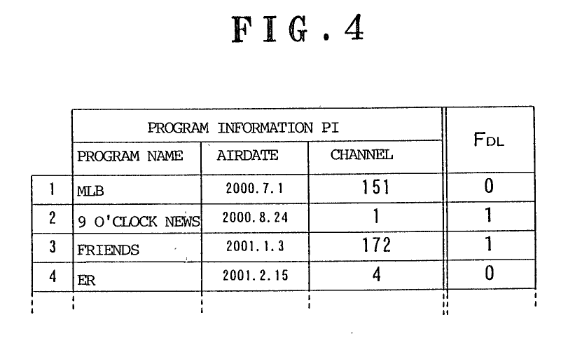

If the user wants to record a television show received at the tuner 11, the user presses the recordation button RE on the remote controller 20 while the tuner 11 is receiving the television program. The remote controller 20 then issues a recordation command to the system control circuit 10. Upon receiving the recordation command, the system control circuit 10 accepts the program information PI from the tuner 11 and writes the program information PI into a recorded program list memory 30. As a result, the program information PI representing the name, date and channel of the television show currently received at the tuner 11 as well as other information are stored in the memory 30, for example as shown in FIG. 4. The system control circuit 10 also stores deletion flags F_{DL} in the memory 30. At the beginning, a logic “0” that indicates no deletion is appended to each program. The system control circuit 10 also supplies a recordation command signal to the hard disc apparatus 12 such that the MPEG signal M1 or M2 which carries the received program is recorded. Upon receiving the recordation command signal, the hard disc apparatus 12 records the MPEG signal M1 or M2 in the data region on the hard disc 120. In order to record the MPEG signal, the hard disc apparatus 12 first stores access cluster information into the route directory region on the hard disc 120 as shown in FIG. 2. The access cluster information indicates (includes) the name of the program and a recordation start cluster. The hard disc apparatus 12 then records a first piece of the MPEG signal M1 or M2 in a cluster, which has the same cluster number as the recordation start cluster, inside the data region on the hard disc 120. When the recordation into the first cluster (i.e., recordation start cluster) is complete, the hard disc apparatus 12 successively selects next clusters in accordance with the order determined by the “next cluster” information recorded in the FAT region, and continues the recordation of subsequent pieces of the MPEG signal into the data region.

(3) Playback

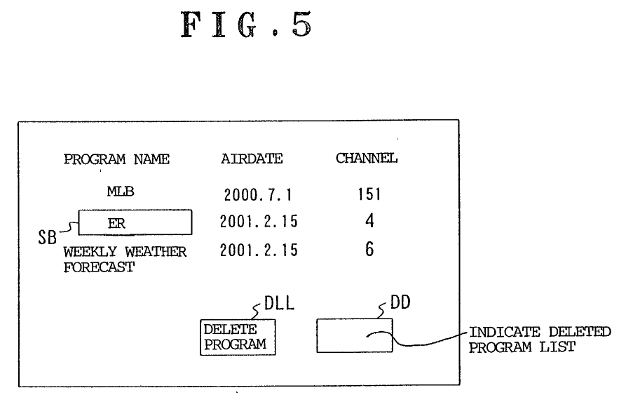

When the user wants to play back a desired program among the recorded programs, the user firsts pushes the list button LD on the operation unit 20. The operation unit 20 sends a recorded program list request command to the system control circuit 10. In response to the request command, the system control circuit 10 reads all programs whose flag F_{DL} is the logic “0” from the program information PI stored in the recorded program list memory 30 (FIG. 4). The system control circuit 10 then creates image data of the list of the extracted programs, and supplies the image data to the OSD image creation circuit 19. The OSD image creation circuit 19 produces an image signal Dc on the basis of the image data and supplies it to the selector 18. In the meantime, the system control circuit 10 issues a selection signal to the selector 18 such that the image signal Dc from the OSD image creation circuit 19 is selected and issued to the display device 200. A series of the above described control causes the display unit 200 to show the list of the recorded program as shown in FIG. 5.

The user then operates the cursor button CSL on the operation unit 20 to move the selection box SB over a name of a desired program (i.e., a program to be played back) as shown in FIG. 5, and presses the playback button P on the operation unit 20. The system control circuit 10 stores information representing (including) the desired program name into a playback program register 31. This information is data to identify the program selected by the selection box SB. The system control circuit 10 then issues a playback start command signal to the hard disc apparatus 12 to start playing back this program. In response to the playback start signal, the hard disc apparatus 12 first retrieves information representing (including) the recordation start cluster of the selected program from the access cluster information stored in the route directory region of the hard disc 120. The hard disc apparatus 12 then starts retrieving the recorded information from the recordation start cluster on the hard disc 120. When the information retrieval from the recordation start cluster is complete, the hard disc apparatus 12 selects subsequent clusters in accordance with the order determined by the next cluster information recorded in the FAT region on the hard disc 120, and continues to retrieve the recorded information from the subsequent clusters.

In the above described manner, a series of playback MPEG signals RM carrying the target program are taken out from the hard disc apparatus 12. An audio/video signal D_{AV} corresponding to the playback MPEG signal RM is then introduced to the display device 200, and the user can watch the played back television show.

(4) Program Deletion (First Approach)

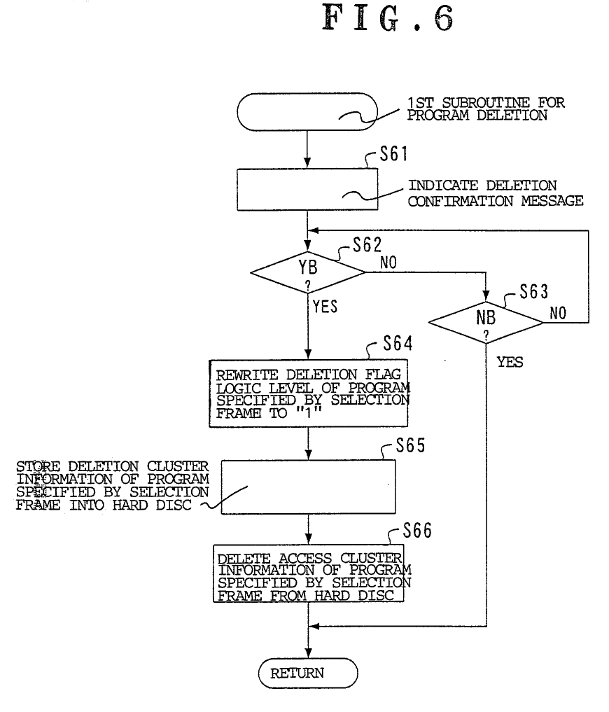

When the user wants to delete a program from the list of the recorded programs of FIG. 5, the user first operates the cursor button CSL on the operation unit 20 to move the selection box SB over the name of the desired program, and clicks. The user then operates the cursor button CSL to click a program deletion button DLL indicated in the recorded program list screen shown in FIG. 5. The system control circuit 10 enters a first subroutine for program deletion as shown in FIG. 6 in response to the clicking of the program deletion button DLL.

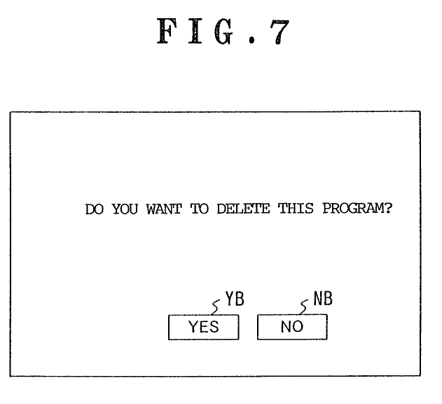

Referring to FIG. 6, the system control circuit 10 first supplies a deletion confirmation message indication command to the OSD image creation circuit 19 to admonish the user to confirm if the selected program should be really deleted. The system control circuit 10 also feeds a selection signal to the selector 18 such that the image signal Dc generated from the OSD image creation circuit 19 is transmitted to the display device 200 (Step S61). Upon execution of Step S61, the program playback screen of the display device 200 switches to a deletion confirmation message screen as shown in FIG. 7. The user operates the cursor button CSL of the operation device 20 to click a YES button YB indicated in the confirmation message screen when the user wants to delete the program. If the user does not want to delete the program, the user clicks a NO button NB.

The system control circuit 10 determines whether the YES button YB is clicked or not (Step S62). If the YES button YB is not clicked, the system control circuit 10 determines whether the NO button NB is clicked or not (Step S63). If the answer is no, the control program returns to Step S62 to repeat the above described operations. Accordingly, the determinations at Steps S62 and S63 are repeatedly made until the user clicks one of the YES button YB and the NO button NB.

When it is determined at Step S62 that the YES button YB is clicked, the system control circuit 10 rewrites the deletion flag F_{DL} of the program having the same program name as that selected by the selection frame SB to a logic level “1” (Step S64). The deletion flags F_{DL} are appended to the respective programs recorded in the list memory 30 of FIG. 4, and the logic level “1” indicates deletion. The system control circuit 10 prepares deletion cluster information representing (including) the name of the program specified by the selection frame SB and the recordation start cluster of this program. The system control circuit 10 sends a command to the hard disc apparatus 12 to store the deletion cluster information in the route directory region of the hard disc 120 (Step S65). Upon receiving the command, the hard disc apparatus 12 writes the deletion cluster information in the route directory region on the hard disc 120. Subsequently, the system control circuit 10 issues a command to the hard disc apparatus 12 to delete the access cluster information of the program specified by the selection frame SB (Step S66). The hard disc apparatus 12 deletes the access cluster information from the route directory region of the hard disc 120 in accordance with the command.

When Step S66 is complete or when the NO button NB is clicked at Step S63, the system control circuit 10 exits the first deletion subroutine and returns to a main routine (not shown).

In the first deletion subroutine, the deletion flag F_{DL} of the program specified by the user is only rewritten to the logic “1”. By pressing the list display button LD shown in FIG. 3, therefore, the specified program is deleted from the recorded program list (FIG. 5) shown in the screen of the display device 200.

It should be noted that the information record/playback apparatus of the invention can also delete a desired program from the recorded program list of FIG. 5 in the following manner.

(5) Program Deletion (Second Approach)

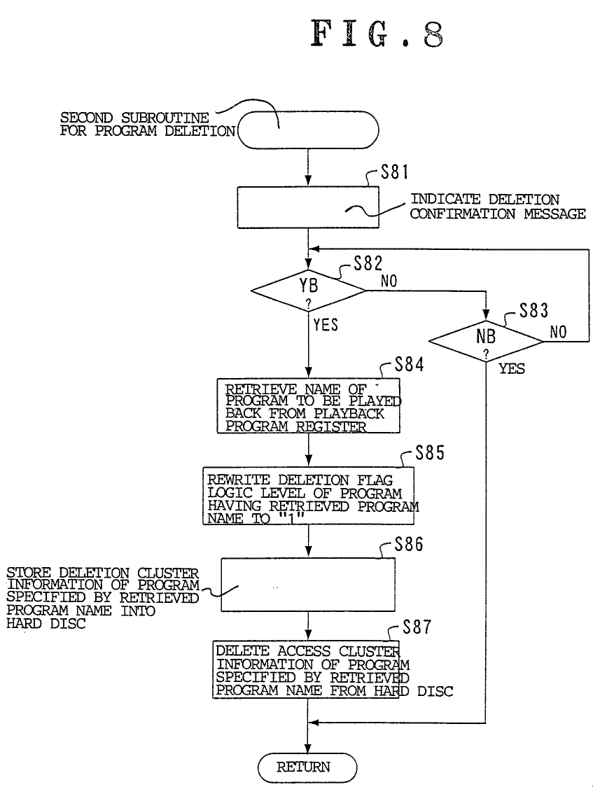

When the above described playback operation is proceeding, the system control circuit 10 enters a second subroutine shown in FIG. 8 if the user presses the program deletion button DL (FIG. 3) on the operation device 20.

In the flowchart of FIG. 8, the system control circuit 10 issues a deletion confirmation message command to the OSD image creation circuit 19 to urge the user to confirm if the specified program should be really deleted. The system control circuit 10 also issues a selection signal to the selector 18 such that the image signal Dc produced by the OSD image creation circuit 19 is introduced to the display device 200 (Step S81). Upon execution of Step S81, the screen of the display device 200 changes from the program playback screen to the deletion confirmation message screen shown in FIG. 7. If the user wants to delete the program, the user operates the cursor button CSL of the operation device 20 to click the YES button YB indicated in the deletion confirmation message screen of FIG. 7. If the user wants to keep the program, the user clicks the NO button NB.

The system control circuit 10 determines whether the YES button YB is clicked or not (Step S82). If the answer is no, the system control circuit 10 determines whether the NO button NB is clicked or not (Step S83). If the NO button is not clicked, the control program returns to Step S82 such that the system control circuit 10 repeats the above described determinations. In other words, the determinations of Steps S82 and S83 are repeatedly made until the user clicks one of the YES and NO buttons.

If it is determined at Step S82 that the YES button YB is clicked, the system control circuit 10 takes information, which represents the name of the program currently played, from the playback program register 31 (Step S84). Subsequently the system control circuit 10 rewrites the logic level of the deletion flag F_{DL} of the program, which has the same program name as the obtained program name information, among those stored in the recorded program list memory 30 (Step S85). The logic level is changed from “0” to “1”. The system control circuit 10 creates deletion cluster information that represents the program name and the recordation start cluster of this program. The system control circuit 10 then issues a command to the hard disc device 12 such that the deletion cluster information is stored in the route directory region shown in FIG. 2 (Step S86). Upon receiving the command, the hard disc device 12 stores the deletion cluster information into the route directory region of the hard disc 120. The system control circuit 10 issues a command to the hard disc device 12 such that the access cluster information of the program having the same name as the clicked program name is deleted (Step S87). In response to the command, the hard disc device 12 deletes the access cluster information of this program from the route directory region on the hard disc 120.

When Step S87 is complete or the NO button NB is clicked at Step S83, the system control circuit 10 exits the second subroutine of FIG. 8 and enters the main routine.

In the second subroutine for the program deletion, the deletion flag F_{DL} of the program currently played is changed to “1” from “0” upon pressing of the deletion button DL. After that, when the list indication button LD is pressed, the program information whose flag is “1” is deleted from the recorded program list shown in the screen of the display device 200.

Therefore, by simply pushing the program deletion button DL on the remote controller 20 during the program playback operation, the information of the program currently played is deleted from the recorded program list.

(6) Deleted Program Recovery

When the user wants to recover a deleted program, the user first presses the list indication button LD of the remote controller 20. Upon pressing of the list indication button LD, the recorded program list of FIG. 5 is displayed in the screen of the display device 200 in the same manner as described earlier.

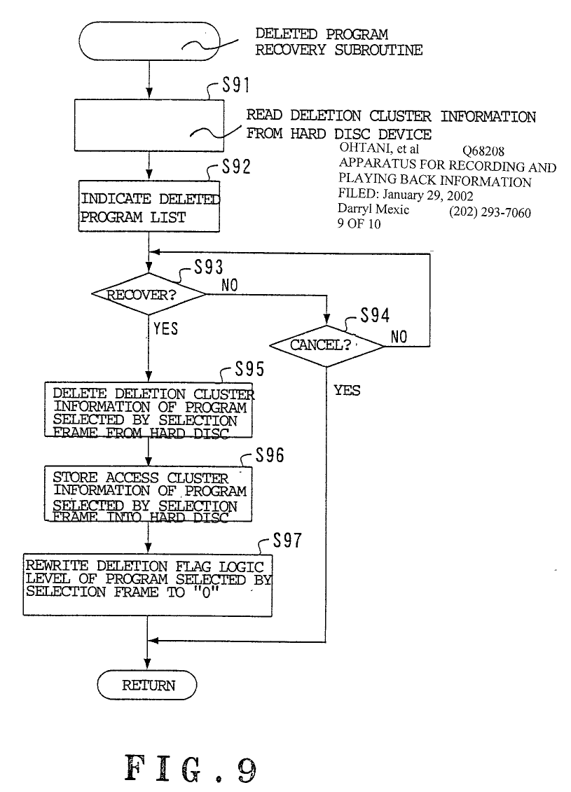

The user then operates the cursor button CSL of the remote controller 20 to click the deleted program list indication button DD shown in the recorded program list screen. The remote controller 20 then transmits a deleted program list indication command to the system control circuit 10. Upon receiving this command, the system control circuit 10 enters a subroutine for deleted program recovery as shown in FIG. 9.

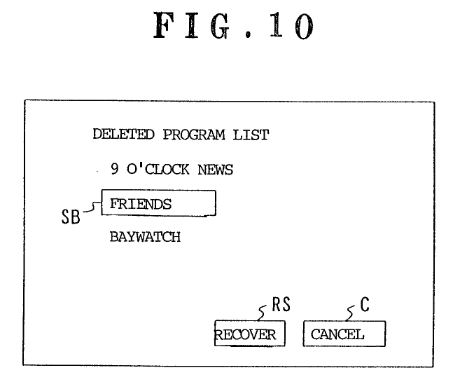

In the flowchart illustrated in FIG. 9, the system control circuit 10 first supplies a command to the hard disc apparatus 12 to read the deleted cluster information (Step S91). Upon receiving the command, the hard disc apparatus 12 reads all the deleted cluster information from the route directory region on the hard disc 120, and supplies it to the system control circuit 10. Subsequently, the system control circuit 10 creates image data of a deleted program list which shows names of programs in the deleted condition. These program names are provided from the deleted cluster information retrieved from the hard disc 12. The system control circuit 10 supplies the image data of the deleted program list to the OSD image creation circuit 19 (Step S92). As a result, the display device 200 shows the list of the deleted programs (i.e., the recorded programs currently in the deleted condition) in the display screen as shown in FIG. 10.

If the user does not want to recover any deleted programs, the user operates the cursor button CSL to click a cancellation button C shown in the display screen of FIG. 10 (i.e., the deleted program list screen). On the other hand, if the user wants to recover a certain program among those present in the deleted program list screen, the user operates the cursor button CSL to move the selection frame SB over the target program and clicks. The user then clicks a recovery button RS shown in the display screen.

The system control circuit 10 determines whether the recovery button RS is clicked or not (Step S93). If the recovery button RS is not clicked, the system control circuit 10 determines whether the cancellation button C is clicked or not (Step S94). If the cancellation button C is not clicked, the control program returns to Step S93 such that the system control circuit 10 repeats the above described determinations. In other words, the determinations of Steps S93 and S94 are repeatedly made until the user clicks one of the recovery button RS and the cancellation button C.

If it is determined at Step S93 that the recovery button RS is clicked, the system control circuit 10 sends a command to the hard disc apparatus to delete deletion cluster information of the program selected by the selection frame SB (Step S95). The system control circuit 10 then creates access cluster information of the program selected by the selection frame SB, and feeds a command to the hard disc apparatus 12 to record the access cluster information (Step S96). Execution of Steps S95 and S96 results in the deletion of the deletion cluster information of the selected program from the route directory region of the hard disc 120 and the creation of the access cluster information of the selected program in the route directory region. Subsequently the system control circuit 10 rewrites the logic level of the deletion flag F_{DL} of the selected program among those stored in the recorded program list memory 30 from “1” to “0” (Step S97). The logic level “0” indicates that this program is in the non-deletion condition. As a result, the program information of the selected program is indicated again in the recorded program list screen of FIG. 5. When Step S97 is complete or Step S94 determines that the cancellation button C is clicked, the system control circuit 10 exits the deleted program recovery subroutine and returns to the main routine.

In the above described recovery subroutine, therefore, the program information once deleted from the recorded program list of FIG. 5 appears again in the recorded program list.

The deletion of the program is simple erasure of indication of the program in the recorded program list (screen) of FIG. 5 in the above described embodiment. It should be noted, however, that the deletion of the program may be physical deletion or erasure of the program data from the hard disc 120.

When the user wants to record a new television show but a remaining recording capacity of the hard disc 120 is insufficient, then a recording area (cluster) of a program whose flag F_{DL} has a logic level “1” is set to an overwritable area. If a plurality of programs have a logic level “1,” the overwritable area is chosen in accordance with predetermined priority. The hard disc apparatus 12 chooses the recorded programs in the deleted condition in accordance with, for example, how many days the program has been stored, or how large area the program occupies. The hard disc apparatus 12 records the new program into the overwritable area prepared in this manner.

Although the MPEG signals carrying the broadcast program or the moving picture data are used as information data to be recorded on the hard disc 120 in the illustrated embodiment, static picture data and/or audio data may be recorded on the hard disc.

Further, the information record/playback apparatus of the present invention is not limited to the hard disc recorder. For instance, any apparatus suited for recording and playing back a video tape, an optical disc and a semiconductor (solid-state) memory can be the information record/playback apparatus of the present invention.

This application is based on a Japanese patent application No. 2001-19824, and the entire disclosure thereof is incorporated herein by reference.

What is claimed is:

1. An apparatus for recording a plurality of pieces of information on a recording medium and reproducing information recorded thereon comprising:
a playback unit for reading a selected piece of information from a plurality of pieces of information recorded on the recording medium to play back the selected piece of information;
a flag setting unit for preparing a deletion flag indicating that the selected piece of information currently played should be deleted, in response to a deletion command issued while the playback unit is playing the selected piece of information, and for attaching the deletion flag to the selected piece of information; and
a generating unit for generating a list of the plurality of pieces of information recorded on the recording medium except for the selected piece of information to which the deletion flag is attached.

2. The apparatus according to claim 1 further including a control unit for rendering a recording area of the selected piece of information to which the deletion flag is attached overwritable when a remaining recording capacity of the recording medium is less than a predetermined capacity.

3. The apparatus according to claim 1 further including an operation unit having a deletion button for issuing the deletion command.

4. The apparatus according to claim 1, wherein the generating unit generates a confirmation message before the deletion command is issued.

5. The apparatus according to claim 1, wherein the selected piece of information remains recorded on the recording medium even after the deletion flag is attached to the selected piece of information.

6. The apparatus according to claim 1 further including a recycle bin for storing the selected piece of information when the deletion flag is attached to the selected piece of information.

7. The apparatus according to claim 1, wherein the selected piece of information is physically deleted from the recording medium when the deletion flag is attached to the selected piece of information.

8. The apparatus according to claim 1, wherein the recording medium is at least one of a hard disc, a video tape, an optical disc and a semiconductor.

9. An apparatus for recording a plurality of pieces of information on a recording medium and reproducing information recorded thereon comprising:
a playback unit for reading a first piece of information from a plurality of pieces of information recorded on the recording medium to play the first piece of information;
a first flag setting unit for preparing a first deletion flag indicating that the first piece of information currently played should be deleted, in response to a first deletion command issued while the playback unit is playing the first piece of information, and for attaching the first deletion flag to the first piece of information;
a second flag setting unit for preparing a second deletion flag indicating that a second piece of information not currently played should be deleted, in response to a second deletion command that designates the second piece of information, and for attaching the second deletion flag to the second piece of information; and
a generating unit for generating a list of the plurality of pieces of information recorded on the recording medium except for the first and second pieces of information to which the first and second deletion flags are attached.

10. The apparatus according to claim 9 further including a control unit for rendering at least one of a first recording area of the first piece of information to which the first deletion flag is attached and a second recording area of the second piece of information to which the second deletion flag is attached overwritable when a remaining recording capacity of the recording medium is less than a predetermined capacity.

11. The apparatus according to claim 9, wherein the generating unit generates a first confirmation message before the first deletion command is issued and generates a second confirmation message before the second deletion command is issued.

12. The apparatus according to claim 9, wherein at least one of the first and second pieces of information remains recorded on the recording medium even after the first and second deletions flags are attached to the first and second pieces of information.

13. The apparatus according to claim 9 further including a recycle bin for storing at least one of the first and second pieces of information when the first and second deletion flags are attached to the first and second pieces of information.

14. The apparatus according to claim 9, wherein at least one of the first and second pieces of information is physically deleted from the recording medium when the first and second deletion flags are attached to the first and second pieces of information.

15. The apparatus according to claim 9, wherein the recording medium is at least one of a hard disc, a video tape, an optical disc and a semiconductor recorder.

16. An apparatus comprising:
means for reading a first piece of information from a plurality of pieces of information recorded on a recording medium to play back the first piece of information;
means for preparing a first deletion flag indicating that the first piece of information currently played should be deleted, in response to a first deletion command issued while the first piece of information is being played, and for attaching the first deletion flag to the first piece of information;
generating means for generating a list of the plurality of pieces of information recorded on the recording medium except for the first piece of information to which the first deletion flag is attached.

17. The apparatus according to claim 16 further including a second flag setting unit for preparing a second deletion flag indicating that a second piece of information not currently played should be deleted, in response to a second deletion command that designates the second piece of information, and for attaching the second deletion flag to the second piece of information, and
wherein the generating means generates a list of the plurality of pieces of information recorded on the recording medium except for the first and second pieces of information to which the first and second deletion flags are attached.

18. The apparatus according to claim 17 further including means for rendering at least one of a first recording area of the first piece of information to which the first deletion flag is attached and a second recording area of the second piece of information to which the second deletion flag is attached overwritable when a remaining recording capacity of the recording medium is less than a predetermined capacity.

19. The apparatus according to claim 17, wherein the generating unit generates a first confirmation message before the first deletion command is issued and displays a second confirmation message before the second deletion command is issued.

20. The apparatus according to claim 17, wherein at least one of the first and second pieces of information remains recorded on the recording medium even after the first and second deletions flags are attached to the first and second pieces of information.

21. The apparatus according to claim 17 further including a recycle bin for storing at least one of the first and second pieces of information when the first and second deletion flags are attached to the first and second pieces of information.

22. The apparatus according to claim 17, wherein at least one of the first and second pieces of information is physically deleted from the recording medium when the first and second deletion flags are attached to the first and second pieces of information.

23. The apparatus according to claim 16, wherein the recording medium is at least one of a hard disc, a video tape, an optical disc and a semiconductor.

24. A method comprising the steps of:
A) playing back a first piece of information among a plurality of pieces of information recorded on a recording medium;
B) preparing a first deletion flag indicating that the first piece of information currently played should be deleted;
C) attaching the first deletion flag to the first piece of information;
D) generating a list of the plurality of pieces of information recorded on the recording medium except for the first piece of information to which the first deletion flag is attached.
